(19) United States
(12) Patent Application Publication
(10) Pub. No.: US 2007/0058569 A1
(43) Pub. Date: Mar. 15, 2007

(54) Integrated presentation and management of communication services

(76) Inventors: Marie McMenamin, Marietta, GA (US); Douglas R. O'Neil, Atlanta, GA (US); Barbara Roden, Atlanta, GA (US); Lauren Argott, Lawrenceville, GA (US); Stanley K. Yeatts, Atlanta, GA (US); Laurie Forehand, Doraville, GA (US); Larry Siegel, Atlanta, GA (US); Brett Dennis Johnson, Acworth, GA (US)

Correspondence Address: MYERS BIGEL SIBLEY & SAJOVEC, P.A., P.O. BOX 37428, RALEIGH, NC, 27627, US

(21) Appl. No.: 11/316,432

(22) Filed: Dec. 22, 2005

Related U.S. Application Data
(60) Provisional application No. 60/705,112, filed on Aug. 3, 2005.

(51) Int. Cl. H04L 12/28

(52) U.S. Cl. 370/254

(57) ABSTRACT

Methods of managing a suite of communication services include providing a central management function configured to manage the status of a plurality of communication services including at least one IP-based communication service and at least one non-IP based communication service, receiving a status of the at least one IP-based communication service and the at least one non IP-based communication service at the central management function from the respective service, and displaying the status of at least one IP-based communication service and the status of the at least one non IP-based communication service.

### CROSS REFERENCE RELATED APPLICATION

This Application is related to and claims the benefit of priority to U.S. Provisional Patent Application No. 60/705,112, filed Aug. 3, 2005, entitled Personal Desktop, the disclosure of which is hereby incorporated herein by reference.

### FIELD OF THE INVENTION

The present invention relates to communication services. In particular, the present invention relates to methods and computer program products for managing a range of communication services by a user of the communication services.f

### BACKGROUND

Electronic communication services, such as local and long distance telephone service, television service, and radio service have been available to consumers for years, and have been widely adopted and used. These longstanding communication services are characterized by ease of operation, limited user interfaces, and relatively high reliability. These factors may help explain why such services have been widely adopted by a large number of people, to the point where television, telephone and radio service is ubiquitous in most countries.

However, due in part to their simplicity, traditional communication services have been limited in many ways. For example, traditional telephone service relies on wireline connections, which may limit the mobility of users. Likewise, traditional television service provided a one-way flow of information from broadcaster to viewers, with little or no ability for viewers to configure the service according to personal preferences.

In recent years, traditional communication services have become more flexible, intelligent, and feature-rich. For example, traditional wireline telephone service providers now offer enhanced services such as call forwarding, call waiting, caller ID, voicemail and the like. Similarly, with the advent of broadband television services through cable and satellite networks, television service providers now offer configurable on-demand television services to subscribers.

At the same time as traditional communication services have become more flexible, intelligent, and feature-rich, the types of available communication services have proliferated, driven in large part by the expansion of the internet. For example in addition to enhanced telephone, television and radio services, a consumer may have access to the internet for email communication, instant messaging, video chat, voice over IP (VoIP) telephony, television over IP (IPTV), and/or other communication services. In addition, wireless communication services have provided additional options for both voice communication and data communication and messaging using, for example, short message service (SMS) and/or multimedia message service (MMS) communications.

In fact, communication services have proliferated to the point where it may be difficult and/or time consuming for a user to manage all of the different communication services that are available to the user. It may be particularly difficult for a user to manage a variety of communication services that have different user interfaces. From the perspective of the service provider, a primary concern is that users may be less likely to adopt new communication services that are seen as complex and/or that operate differently from communication services with which they are more familiar.

In another aspect, it may be difficult and/or confusing for persons wishing to contact the user to know which communication means are available to the user, and of the available communication means, which is an appropriate one to use.

### SUMMARY

Some embodiments of the invention provide methods of managing a suite of communication services, including providing a central management function configured to manage the status of a plurality of communication services including at least one IP-based communication service and at least one non-IP based communication service, receiving a status of the at least one IP-based communication service and the at least one non IP-based communication service at the central management function from the respective service, and displaying the status of at least one IP-based communication service and the status of the at least one non IP-based communication service.

The methods may further include initiating the at least one IP-based communication service by the central management function.

The methods may further include retrieving logon credentials for the at least one IP-based communication service from a database, and providing the logon credentials to the at least one IP-based communication service. Initiating the at least one IP-based communication service may include initiating a plurality of IP-based communication services by the central management function.

The methods may further include retrieving a respective set of logon credentials for each of the plurality of IP-based communication services from a database, and providing each set of logon credentials to respective ones of the plurality of IP-based communication services.

The central management function may be configured to manage the status of a plurality of communication services available to a first user, the method may further include receiving, at the central management function, a status of a communication service of at least one other user, and displaying the status of the communication service of the at least one other user.

Receiving a status of a communication service of at least one other user may include receiving a status of a plurality of communication services of the at least one other user, and displaying the status of the communication service of the at least one other user may include displaying the status of the plurality of communication services of the at least one other user.

Displaying the status of the plurality of communication services of the at least one other user may include displaying an icon indicative of the status of a communication service of the at least one other user.

The methods may further include receiving an updated status of at least one communication service, and updating the displayed status of at the least communication service in response to receiving the updated status. The status of the communication service of the at least one other user may include application activity, user state, network presence, location, security/authentication level, and/or alias.

The methods may further include receiving a request from the user to change the status of at least one of the plurality of communication services, and responsively changing the status of the at least one of the plurality of communication services.

The methods may further include receiving a request from the user to change a global status of the user, and responsively changing the status each of the plurality of communication services to match the global status of the user. The global status may include availability.

The methods may further include receiving a request from the user to terminate all communication services, responsively determining which of the plurality of communication services may be active, and terminating the active services.

Methods of managing a suite of communication services according to further embodiments of the invention include providing a central management function configured to manage the status of a plurality of IP-based communication services, receiving a status of the plurality of IP-based communication services at the central management function from the respective service, and displaying the status of plurality of IP-based communication services.

The methods may further include initiating the at least one IP-based communication service by the central management function, and retrieving logon credentials for the at least one IP-based communication service from a database, and providing the logon credentials to the at least one IP-based communication service.

Some embodiments of the invention provide a computer program product for managing a suite of communication services, the computer program product including a computer readable storage medium having computer readable program code embodied in the medium, the computer readable program code including computer readable program code configured to provide a central management function configured to manage the status of a plurality of communication services including at least one IP-based communication service and at least one non-IP based communication service, computer readable program code configured to receive a status of the at least one IP-based communication service and the at least one non IP-based communication service at the central management function from the respective service, and computer readable program code configured to display the status of at least one IP-based communication service and the status of the at least one non IP-based communication service.

A computer program product for managing a suite of communication services according to some embodiments of the invention includes a computer readable storage medium having computer readable program code embodied in the medium, the computer readable program code including computer readable program code configured to provide a central management function configured to manage the status of a plurality of IP-based communication services, computer readable program code configured to receive a status of the plurality of IP-based communication services, and computer readable program code configured to display the status of the plurality of IP-based communication services.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic diagram showing the interconnection of various communication terminals according to some embodiments of the invention;

FIGS. 2 and 3 are schematic diagrams showing the logical interconnection of various communication services according to some embodiments of the invention;

FIGS. 4-8 are diagrams of display windows that are configured to present and manage a variety of communication services according to some embodiments of the invention; and

FIG. 9 is a block diagram illustrating operations of a central management function according to some embodiments of the invention.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the invention provide methods, systems and computer program products configured to manage a suite of communication services including one-way and/or two way communication services. In particular, some embodiments of the invention provide a central management function configured to manage the status of a number of communication services, including both IP-based communication services such as email, instant messaging, video chat, voice over IP (VoIP), TV over IP (IPTV) and/or other IP based services, as well as non IP-based communication services such as wireline telephony, wireless telephony, wireless short messaging, broadband television services, and/or other communication services.

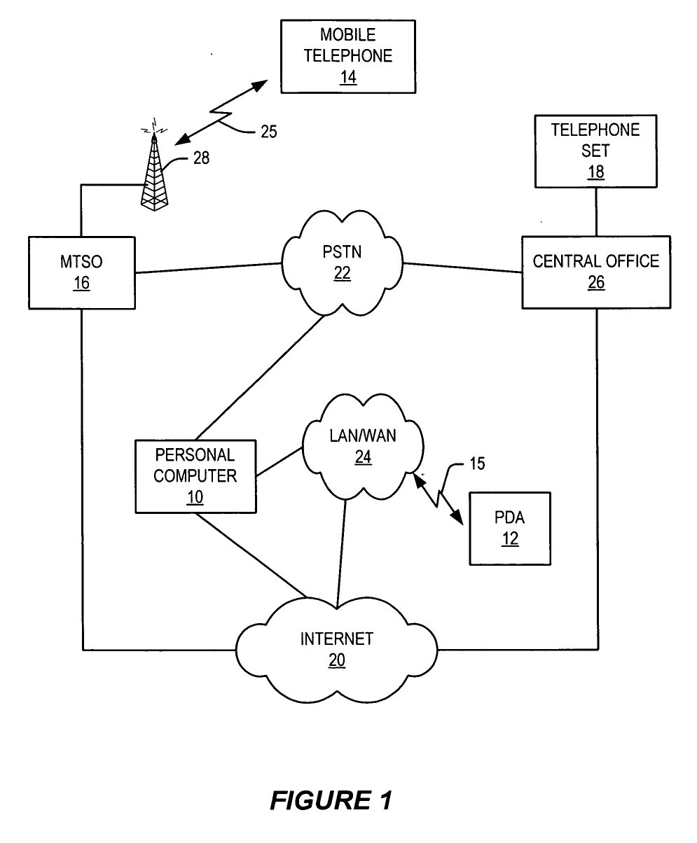

FIG. 1 illustrates a number of communication devices that may be used by a user to access various communication services. For example, a user may have a number of communication terminals, including a personal computer 10, such as a desktop, laptop and/or palmtop computer, a personal digital assistant (PDA) 12, a mobile telephone 14 for communicating over a wireless telephone system and/or a telephone handset 18 for communicating over a landline telephone system.

Each communication terminal may be configured to access one or more voice and/or data communication networks. For example, the computer 10 may be configured to communicate via an internet protocol-based network, such as the internet 20, and/or via another type of network such as a public switched telephone network (PSTN) 22 and/or other public and/or private data communication networks. The computer 10 may be configured to communicate over a wireless and/or wired local area/wide area network connection (LAN/WAN) 24.

The user may have a personal digital assistant (PDA) 12, which may be configured to communicate via the internet 20 and/or via a LAN/WAN network 24 using one or more network protocols. Likewise, the user may have a mobile telephone 14 that is connected to a mobile telephone switching office (MTSO) 16 via a wireless connection 25 to a base station 28. The MTSO 16 may in turn be connected to the internet 20 to permit the mobile telephone 14 to establish IP-based communications using the internet 20. The MTSO 16 may also be connected to the PSTN 22 to permit the mobile telephone to establish a voice communication with a telephone handset connected to the PSTN 22. The MTSO 16 may also be connected to a backbone communication network (not shown) that manages calls to other wireless terminals.

A mobile telephone can communicate via the base station 28 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). With a wireless LAN (WLAN) module, the mobile telephone 14 may also communicate using a communication protocol that may include, but is not limited to, 802.11a, 802.11b, 802.11e, 802.11g, and/or 802.11i. A mobile telephone 14 may also be configured to communicate directly over the PSTN 22.

A mobile telephone 14 may be configured to transmit and/or receive a digital data signals using, for example, the MTSO 16, the PSTN 22 and/or another network. However, it will be appreciated that data communication, such as communication using SMS services, may be accomplished without using the MTSO 16 or the PSTN 22.

A computer 10, PDA 12 and/or mobile telephone 14 may include a global positioning system (GPS) receiver therein or other circuitry for tracking the user's current location. For example, a mobile telephone 14 may include circuitry therein for determining a users location based on cellular telephone signals.

A standard telephone set 18 may be used to make local and/or long distance telephone calls to other terminals connected to the PSTN 22. Such telephone calls are managed by a central switching office 26.

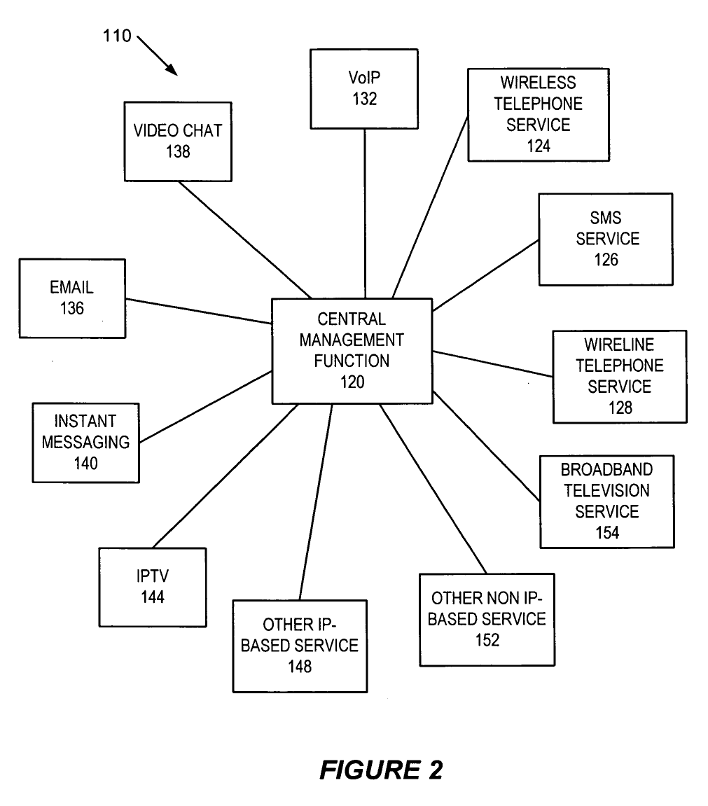

FIG. 2 illustrates the management of a plurality of communication services through a central management function 120, which collects, manages, and displays information concerning the operation of a suite of communication services that may be available to a user. As illustrated in FIG. 2, such communication services may include IP-based communication services, such as email service 136, instant messaging 140, video chat 138, voice over IP (VoIP) 132, IPTV service 144 and/or other IP-based communication services 148. The communication services managed by the central management function 120 may include non IP-based services such as wireless telephone service 124 (which may include cellular, PCS and/or satellite wireless service), SMS service 126, standard (wireline) telephone service 128, broadband television service 154 and/or other non IP-based communication services.

The central management function 120 may provide a portal for managing a suite of communication services. To that end, the central management function 120 may provide a single interface for launching a plurality of communication services. The central management function 120 may also provide status information for the services, as well as alerts, service updates, and upgrades for the services in a single location. By coordinating and managing a number of communication services using a central management function 120, the burden of managing a large number of communication services may be reduced. Furthermore, the interface of a central management function 120 may unify a number of communication modes to provide a single, comprehensive and intuitive communication interface for a user. Such an interface may help a user to better utilize and manage available communication services.

The central management function 120 may be implemented as a standalone software module configured to operate, for example, on a user computer 10, PDA 12, mobile telephone 14, and/or other device including, for example, a television set-top box. In some embodiments, the central management function 120 may be implemented as a server application running on a server (not shown) that may be accessible, for example, through the internet. Accordingly, the central management function 120 may run as a local application on a user computing device, or it may run as a server application. If the central management function 120 is implemented as a server application, the user may access the central management function 120 by means of a client application running on a user computing device. In some embodiments, the client application may be a dedicated client application that is specially configured to access the central management function 120 server application. In other embodiments, the central management function 120 may be configured as a web-based server application that is accessible, for example, using an internet browser.

Implementing the central management function 120 as a server application may have particular benefits, in that a user may have additional flexibility in using a server-based central management function 120. For example, many electronic communication devices, including computers 10, wireless telephones 14 and/or PDAs 12 are equipped with internet browser client software. Thus, a user may be able to access the central management function 120 from a variety of locations. Moreover, it may not be necessary to provide custom software in each electronic device from which a user may wish to access the central management function 120. In addition, as will be apparent from the discussion below, implementing the central management function 120 as a server application may be particularly beneficial if the central management function 120 is run on a server operated by a provider of one or more of the communication services that are managed by the central management function 120.

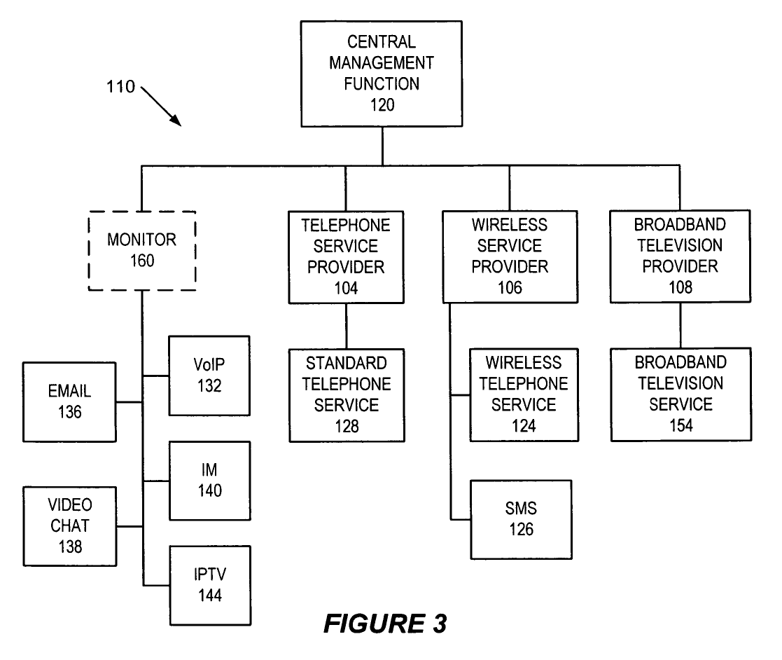

The central management function 120 may communicate with one or more of the communication services being managed. For example, referring to FIG. 3, the central management function may communicate with a telephone service provider 104 to obtain information about a standard telephone service 128 utilized by the user. Likewise, the central management function 120 may communicate with a wireless service provider 106 to obtain information concerning wireless telephone services 124 and/or data communication services such as SMS services 126 utilized by the user. As further illustrated in FIG. 3, the central management function 120 may communicate with a broadband television service provider 108 to obtain information concerning the usage of broadband television services 154.

As further illustrated in FIG. 3, the central management function 120 may obtain information concerning IP-based services employed by a user, such as email service 136, instant messaging 140, VoIP 132, video chat 138, IPTV 144, etc. Information concerning the IP-based services may be collected, for example, directly from client applications by which the services are accessed. Alternatively or additionally, information concerning IP-based communications may be collected through an optional IP communication monitor 160 that may be installed on a user device.

For example, a user may access email and/or instant messaging services through client applications running on a personal computer 10. Information concerning email communications may be provided directly to the central management function 120 from the email client. Likewise, information concerning instant messaging communications may be provided directly to the central management function 120 by the instant messaging client. Such an arrangement may require that the email client and/or the instant messaging client include special coding, however. Therefore, in some embodiments, information concerning IP-based communications such as email, instant messaging, VoIP, and the like, may be collected and forwarded to the central management function 120 by means of an optional IP communication monitor 160. The monitor 160 may run on a user computing device on which an IP-based client is running, and may monitor IP-based communications occurring on the computing device. Information concerning the IP-based communications may be forwarded by the monitor 160 to the central management function 120.

It will be appreciated that the monitor 160 may be installed on a computing device capable of accessing IP-based communication services, including, for example, personal computers 10, PDAs 12 and/or mobile telephones 14. Moreover, it will be appreciated that where the central management function 120 runs as a local application on the same computing device as the IP-based service client runs, the central management function 120 may be configured to monitor IP-based communications being performed on the computing device. Thus, the central management function 120 itself may perform the monitoring function.

As will be further appreciated, two-way communication may be provided between the central management function 120 and the communication services (including the communication service clients in the case of IP-based communication services and/or the communication service providers in the case of non IP-based communication services). In that way, the central management function 120 may not only collect and manage information concerning the various communication services, but the central management function 120 may also issue commands and/or instructions to the communication service clients and/or the communication service providers, for example to configure the communication services.

The central management function 120 may collect information concerning each of the communication services. For example, the central management function 120 may collect information regarding the current status of a communication service, such as, for example, whether the service is currently operational or not, and/or whether the service is currently busy or not. Other information that may be collected may include information concerning particular communications handled by the communication service, such as history information for the communication service. That is, the central management function 120 may keep a log of communications for each communication service used by the user. The log may include such information as the date/time of each communication, the intended recipient, whether the communication was successful, the type of communication (e.g. email, telephone call, etc.), the subject of the communication, the duration/size of the communication, the cost associated with the communication, and/or any other information desired to be maintained about the communication.

Other information may be collected, such as the user's current location if, for example, the user is using a communication device that includes the ability to track location such as, for example, a device equipped with a GPS receiver and/or a mobile telephone equipped with cellular-based location tracking functionality. Even information concerning what applications the user is currently running and/or what programs the user is currently watching and/or listening to may be collected by the central management function 120. The types of information that are collected by the central management function 120, and the manner in which the collected information is displayed, may be customized be the user.

The central management function 120 may provide an indication of presence of the user and/or the status of the user's use of one or more communication services to other users. For example, the central management function 120 may provide presence information to other users through the other user's communication clients and/or through other users' central management functions, if any. Providing presence information from one user's central management function 120 to another user's central management function 120 may permit the users to share enhanced presence information with each other. For example, a central management function 120 may provide presence information for a user across a variety of communication services. That is, according to some embodiments of the invention, one user may be able to easily vie the presence and/or status of another user on a range of communication services. In some embodiments, the log may be assembled and/or updated dynamically on an as-needed basis. For example, when the user requests a history of communications with a particular user and/or using a particular communication service, the central management function 120 may dynamically poll the communication services and assemble/update the desired history. Such update/assembly of the log may occur automatically when a request is made, or based on a command by the user.

Conventionally, in order to determine whether a user was available to receive a communication by means of a particular communication service, it was necessary to open the communication service client for the particular communication service and check the presence/status of the other user. According to some embodiments of the invention, the presence of another user with respect to a range of communication services may be presented by a user's central management function 120 in a single interface. Thus, it may not be necessary, for example, to open an instant messaging client to determine if a desired user is currently online able to receive instant messages, then to open a video chat client to determine if the desired user is currently able to initiate a video chat session, and so on, in order to determine a user's preference with respect to a number of communication services. Moreover, presence/status may be provided for communication services that may not normally provide presence and/or status information. For example, a central management function 120 may collect and display information relating to another user's current availability via mobile telephone and/or standard telephone.

A central management function 120 may also collect information concerning a communication service that may not be shared with other users, but may only be presented to the user. Such information may include, for example, billing and/or usage information.

It will be appreciated that the ability of a central management function 120 to provide presence and/or status information to third parties may be configured by the user such that presence/status information need not be shared if not so desired by the user. Moreover, the central management function 120 may be configured such that certain information is shared only with certain other users. For example, a user may wish to share information such as the user's current location with some users, but not others.

In order to simplify the process of obtaining information about a user's communication services, it may be desirable for the central management function 120 to be operated as a server application by one of the service providers of the user's communication services. It may be easier, faster, more efficient and/or less costly for the central management function 120 to collect information regarding the communication services being provided by the service provider that is running the central management function 120.

It will be appreciated that while in FIG. 3 the telephone service provider 104, the wireless service provider 106 and the broadband television service provider 108 are illustrated as different providers, a user may choose to obtain more than one communication service from the same communication service provider. For example, it is not uncommon for a user to obtain both standard telephone service and wireless telephone service from the same service provider. In addition, it is frequently becoming possible for a user to purchase telephone, television and internet services from the same service provider. In cases where more than one service is being obtained from the same service provider, it may be particularly beneficial for the service provider to operate the central management function 120 as a server application.

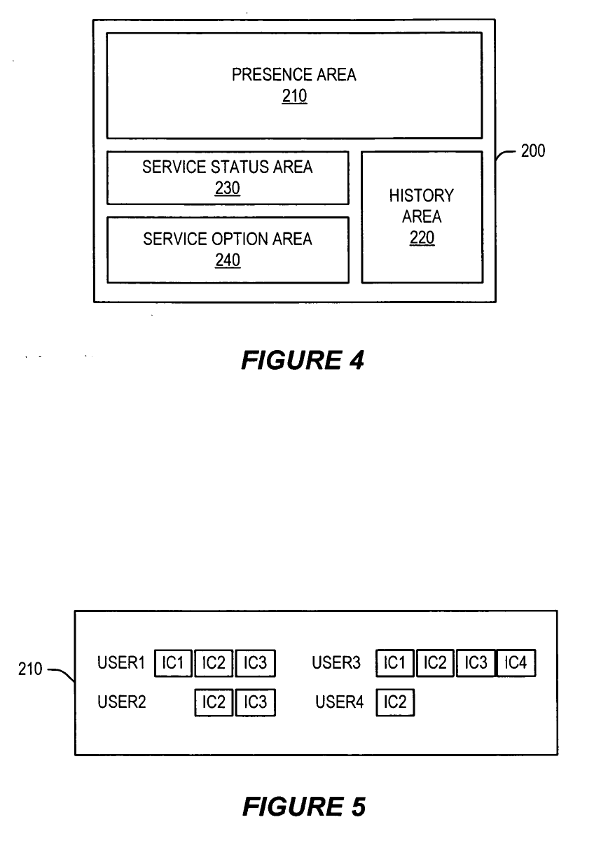

FIG. 4 illustrates an exemplary screen 200 that may be presented to a user when accessing the central management function 120. As shown in FIG. 4, the central management function access screen 200 may include a number of functional areas such as a presence area 210, a service status area 230, a history area 220 and/or a service option area 240. It will be appreciated that these functional areas may be presented in one or more different windows or sub-windows on a display screen. Furthermore, it is not necessary that all functional areas are displayed simultaneously. Rather, some of the windows could be hidden behind other windows and/or otherwise inactivated. Moreover, a user may configure the central management function 120 to display the functional areas in a desired manner. In particular, the manner in which the functional areas are displayed may depend on the type of device on which the user is running/accessing the central management function 120. For example, due to the limited screen size of portable devices such as mobile telephones, PDAs and the like, the central management function 120 may display substantially less information at a given time when it is accessed with such a device.

FIG. 5 illustrates a possible arrangement of a presence area 210 of a display screen of a central management function 120. The presence area 210 may display the presence/status of one or more other users. To that end, the presence area 210 may include a number of user names of other parties (e.g. USER1, USER2, etc.). These user names may be names, aliases, email addresses, or any other code that uniquely identifies another user whose presence the user wishes to track. Of course, in order to be able to dynamically obtain presence/status information about the other party, it may be desirable to require the consent of the other party. Next to each of the other users names is at least one icon IC1-IC4. An icon may represent a particular communication service used by the user next to whose name the icon is located. For example, one icon may represent email service, while another icon may represent an instant messaging service. Still other icons may represent wireless telephone service, SMS service, television service, etc. For each service, a first icon may be displayed when the particular service is available and free to be used, while another icon may be displayed when the particular service is busy. Yet another icon may be displayed when the service is temporarily unavailable, such as when the user in question has placed the service into a “do not disturb” status. Thus, for example, according to the example of FIG. 5, USER1 is associated with three communication services, as represented by the icons IC1, IC2, and IC3. The status of these icons may represent the availability of using these communication services to contact USER1.

For example, the icon IC1 may be associated with email service, the icon IC2 may be associated with instant messaging service, and the icon IC3 may be associated with wireless telephone service. The icon IC1 may indicate that USER1 is currently capable of receiving email. The icon IC2 may indicate that USER1 uses an instant messaging service, but that USER1 is not currently signed on to the service. The icon IC3 may indicate that USER1 subscribes to a mobile telephone service, and that USER1's mobile telephone is currently operating and is not busy. Thus, by looking at a single presence area 210, a user may be able to determine an appropriate mode of communication with which to contact USER1.

The presence area 210 may indicate many different types of status for another user. For example, the presence area may indicate a user's application activity (i.e., what application they are currently running), a user state (e.g. online, offline, etc.), a network presence (e.g. whether a mobile telephone is connected to a home network, roaming network or other network), location information, the security of the connection, and others.

The presence area 210 may also indicate whether a particular user's presence has been authenticated. For example, when the central management function 120 receives a notification that another party is online (“present”), the central management function 120 may authenticate the other party. Authentication techniques, such as public/private key authentication, are well known. For example, the central management function 120 may encrypt a random string using a public key of the other party. The other party may decrypt the encrypted random string using its private key and send the decrypted random string back to the central management function 120 as clear text. If the string received from the other party matches the random string, the identity of the other party is assumed to be authenticated.

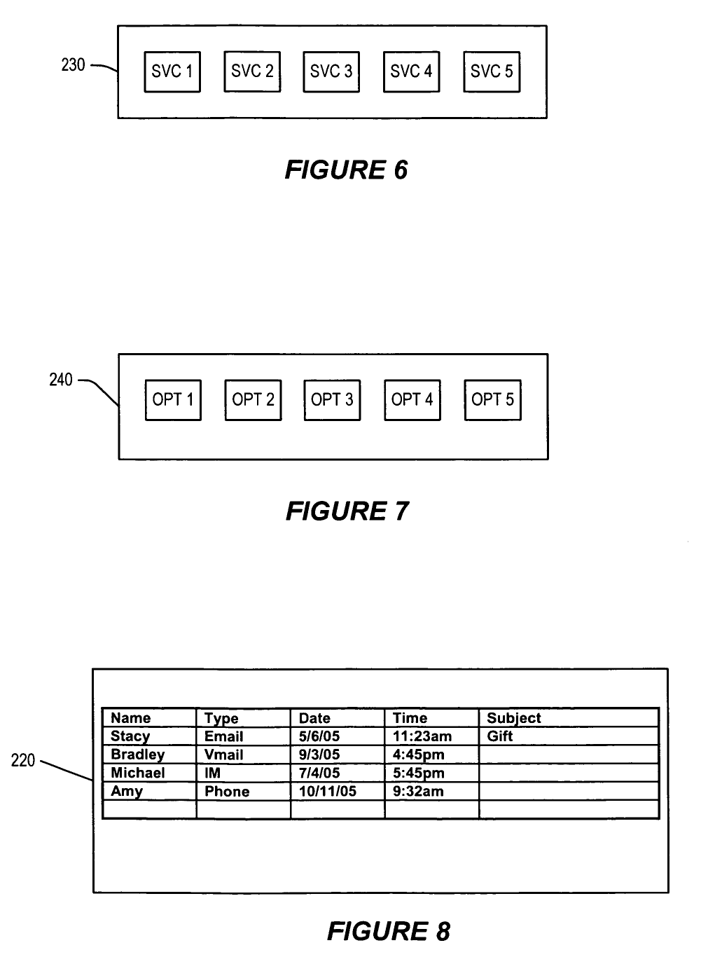

FIG. 6 illustrates a service status area 230 for a user of the central management function 120. As shown in FIG. 6, the service status area 230 may include one or more icons SVC1-SVC5, each of which may correspond to a communication service that is available to the user and whose status is being managed by the central management function 120. It will be appreciated that while five icons are shown in FIG. 6, more or less than five service icons SVC1-SVC5 may be displayed.

The service status area 230 may include icons for communication services such as email service, instant messaging, wireless telephone service, etc. The particular icon displayed may be indicative of a current status of the service. For example, a particular service may be shown with an icon that is disabled (e.g. grayed out or otherwise altered) when the service is unavailable. Many other options are possible, and the icon for a particular service may change depending on other aspects of the service. For example, for communication services which provide a limited number of minutes per month, such as a wireless telephone service, the icon used to represent the service may change depending on the number of minutes used and/or the number of minutes remaining in the plan. Similarly, the icon may change if the wireless telephone is currently roaming out of network and use of the wireless telephone would incur additional charges. Further, a different icon for a service may change if the service is placed by the user into a state such as a “do not disturb” state. A service icon may further indicate the number of “buddies” that are online and/or currently available using the service.

When a particular service icon SVC1-SVC5 is selected, options associated with the selected service may be shown in the service options area 240 as shown in FIG. 7. The options that are associated with a service will depend on the particular service that was selected. For example, for a VoIP service, a wireless telephone service and/or a standard telephone service, the options may include voice mail, call log, address book, call handling, calendar, administrative settings, etc. Likewise, for an email service, the options may include address book, calendar, administrative settings, etc. For an IPTV service and/or a broadband television service, the options may include a channel guide, a list of recorded shows, administrative settings, etc. The displayed set of options may further include an option for opening an application associated with the service (e.g. an email client, an instant messaging client, etc.)

The displayed set of options may further include an option for obtaining support (help) for the selected service. When the support option is selected, the central management function 120 may open a service portal that is specific to the selected service, so that when a user requests support, the support function can more quickly assist the user.

FIG. 8 illustrates an example of a history area 220. As shown in FIG. 8, the history area 220 may display a history of the user's communications. The history area 220 may be organized by date/time, by communication type, by name of the party being communicated with and/or other criteria. The history area 220 may be configured, for example, to display communications with a particular entity (for example, whenever the name of the entity is selected in an address book or in the presence area 210), communications using a particular communication service (for example, whenever an icon for the service is selected in the service area 230), communications made over a particular time period, etc. For example, the history area 220 could be configured to show all communications with a particular person. Communications may be cross-referenced using an address book to associate, for example, an email address and/or a telephone number with a user alias.

The history area 220 may be populated dynamically by the central management function 120 in response to request by the user to display a particular communication history. For example, when a user requests the central management function 120 to display a particular communication history (for example, a list of all communications with USER1), the central management function 120 may retrieve the profile of USER1 from an address book. The profile may include identity information about USER1, including name, alias, telephone numbers (including wired and wireless), email address, instant messaging id, and/or other information.

For example, the profile may be converted into a common format using, for example, XML format, and routed to one or more of the available communication services along with a request for communication history information for the profile in question. Alternatively, the request could simply be broadcast to a namespace where it may be received by any of the communication services, and the communication services may respond to the broadcast request if it involves a request for information maintained by the particular communication service. The communication services may examine the profile and identify messages that match an identity in the profile. The communication service may then respond to the central management function 120 with a communication history for that service. The central management function 120 may assemble the responses from the various communication services, and display the result in the history area 220.

According to some embodiments of the invention, a central management function 120 may be configured to provide a universal address book that may be automatically/dynamically populated based on inputs from the various communication services that are being managed by the central management function 120. The address book managed by the central management function 120 may be updated in response to changes in the address books of the various services. Thus, for example, if a telephone number is updated in the address book of a user's mobile telephone, the telephone number change may be updated in the universal address book maintained by the central management function 120, either automatically and/or in response to a user command.

In addition to providing information regarding the current status of a user's communication service, the central management function 120 may be configured to send status change requests to the communication services to reflect a desired change in the user's status. As on example, a user may wish to let others know that he or she is temporarily unavailable. In that case, the central management function 120 may place one or more of the services in a “do not disturb” mode, in which incoming messages/calls may be queued. Some communication services may also be placed into an “out of office” mode by the central management function 120 in which incoming messages/calls are replied to with an “out of office” response.

The kind of “out of office” response that is sent may depend on the mode of communication involved. For example, for text communications such as email, SMS, instant messaging, etc., the “out of office” response may include text message. For audio/visual communication mode, such as video chat, telephone, etc., the “out of office” response may include a voice recording. In either case, the central management function 120 may provide an appropriate “out of office” message to be sent by one or more communication services managed by the central management function 120. For example, a user may only need to prepare one text “out of office” message and/or one audio “out of office” recording. When the status of the user is placed into “out of office” status at the central management function 120, the central management function 120 may notify each of the managed communication services of the “out of office” status of the user, and provide an “out of office” reply to be used by the communication service that is appropriate to the mode of communication.

Other rules may be configured to provide dynamically updated status to other parties. For example, the central management function 120 could be configured to place one communication mode into an “unavailable” state whenever another communication mode is being used. For example, the central management function 120 could be configured to place wireless telephone service and/or VoIP service into “unavailable” status whenever the user is currently talking on his or her standard telephone line. Similarly, the central management function 120 could be configured to show the user's status for instant messaging and/or video chat as available whenever the IPTV service is being used. Many other rules/configurations are possible.

The communication status of a user may be scheduled on a calendar maintained by the central management function 120. For example, a user may specify that he or she is not available via wireless communication modes during certain hours. During the specified hours, the central management function 120 may automatically change the status of the user with respect to wireless communication modes to “do not disturb.” The scheduled status of a user may be configured to provide different status information to different other parties. For example, a user may provide that for some parties, the user's status is provided as not available for communication during particular hours, while for other parties, the user's status may be provided as available.

In addition to providing global status changes, the central management function 120 may provide a single facility for signing onto a number of communication services. The central management function 120 may store logon credentials (e.g. username/password combinations) for one or more of the communication services managed by the central management function 120 in a database. At start-up or on a command of the user, the central management function 120 may initiate a predefined set of communication services and provide appropriate logon credentials to those communication services. Thus, instead of the user having to sign on to multiple communication services, the central management function 120 may sign the user onto a number of communication services, either automatically and/or in response to a user command.

In addition to storing logon credentials, the central management function 120 may also store information relating to financial accounts, such as credit card numbers, account numbers, etc., to facilitate online purchasing using various communication modes, including internet communications, IPTV purchases, and the like.

Likewise, the central management function 120 may terminate active communication services, either automatically or in response to a user command. For example, in response to a user command to terminate all active services, the central management function 120 may determine which of the communication services is active and terminate the active services.

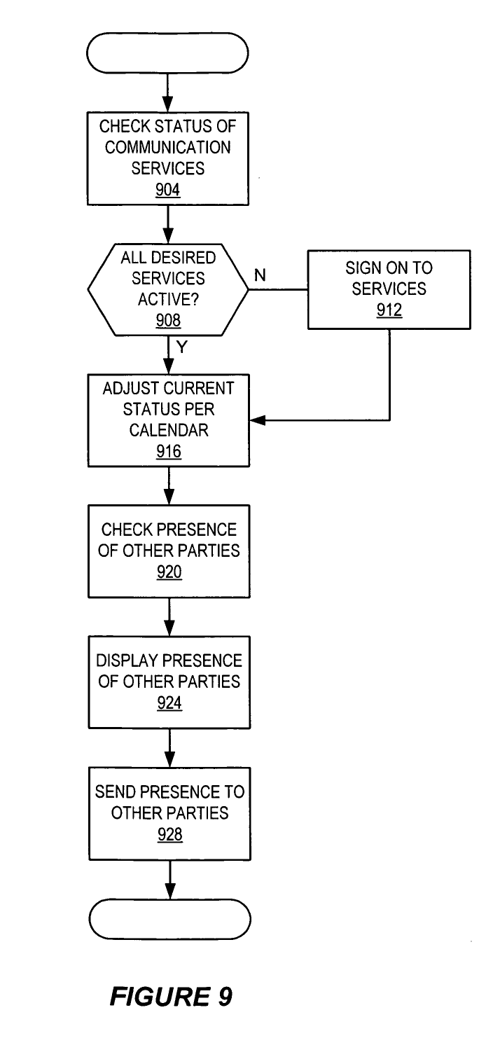

FIG. 9 illustrates operations of a central management function 120 according to some embodiments of the invention. As shown therein, when a central management function 120 is initialized, the central management function 120 may first check the status of communication services managed by the central management function 120 (block 904). The central management function 120 then determines if all desired services are active (block 908). For example, a user configuration setting may provide that certain communication services, such as email or text messaging, for example, are to be activated when the central management function 120 is initialized. If one or more desired communication services are inactive, the services are activated by the central management function 120 (block 912). As part of the activation, the central management function 120 may provide logon credentials to the service provider as described above.

The central management function 120 may adjust the status of one or more of the communication services managed by the central management function 120 according to a setting of a calendar maintained by the central management function 120 (block 916). For example, the central management function 120 may check to see if the status of the communication services matches the status specified in the calendar. The central management function 120 may check to see if the user is currently in an “out of office” status. If the user is in such a status, the status of the communication services may be adjusted accordingly.

The central management function 120 may check the presence of other parties, e.g. other parties that are provided on a “buddy list” maintained by the central management function 120 (block 920). The presence of the other users may then be displayed, for example in a presence area of the display screen of the central management function 120 (block 924). Finally, the central management function 120 may notify other parties of the users presence and status on the various communication services managed by the central management function 120 (block 928).

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer usable program code embodied in the medium. Any suitable computer readable medium may be utilized including hard disks, CD ROMs, optical storage devices, a transmission media such as those supporting the Internet or an intranet, or magnetic storage devices.

The present invention is described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A method of managing a suite of communication services, comprising:
providing a central management function configured to manage the status of a plurality of communication services including at least one IP-based communication service and at least one non-IP based communication service;
receiving a status of the at least one IP-based communication service and the at least one non IP-based communication service at the central management function from the respective service; and
displaying the status of at least one IP-based communication service and the status of the at least one non IP-based communication service.

2. The method of claim 1, further comprising:
initiating the at least one IP-based communication service by the central management function.

3. The method of claim 2, further comprising:
retrieving logon credentials for the at least one IP-based communication service from a database; and
providing the logon credentials to the at least one IP-based communication service.

4. The method of claim 2, wherein initiating the at least one IP-based communication service comprises initiating a plurality of IP-based communication services by the central management function.

5. The method of claim 4, further comprising:
retrieving a respective set of logon credentials for each of the plurality of IP-based communication services from a database; and
providing each set of logon credentials to respective ones of the plurality of IP-based communication services.

6. The method of claim 1, wherein the central management function is configured to manage the status of a plurality of communication services available to a first user, the method further comprising:
receiving, at the central management function, a status of a communication service of at least one other user; and
displaying the status of the communication service of the at least one other user.

7. The method of claim 6, wherein receiving a status of a communication service of at least one other user comprises receiving a status of a plurality of communication services of the at least one other user, and displaying the status of the communication service of the at least one other user comprises displaying the status of the plurality of communication services of the at least one other user.

8. The method of claim 7, wherein displaying the status of the plurality of communication services of the at least one other user comprises displaying an icon indicative of the status of a communication service of the at least one other user.

9. The method of claim 1, further comprising:
receiving an updated status of at least one communication service; and
updating the displayed status of at the least communication service in response to receiving the updated status.

10. The method of claim 7, wherein the status of the communication service of the at least one other user includes application activity, user state, network presence, location, security/authentication level, and/or alias.

11. The method of claim 1, further comprising:
receiving a request from the user to change the status of at least one of the plurality of communication services; and
responsively changing the status of the at least one of the plurality of communication services.

12. The method of claim 1, further comprising:
receiving a request from the user to change a global status of the user; and
responsively changing the status each of the plurality of communication services to match the global status of the user.

13. The method of claim 1, wherein the global status comprises availability.

14. The method of claim 1, further comprising:
receiving a request from the user to terminate all communication services;
responsively determining which of the plurality of communication services is active; and
terminating the active services.

15. A method of managing a suite of communication services, comprising:
providing a central management function configured to manage the status of a plurality of IP-based communication services;
receiving a status of the plurality of IP-based communication services at the central management function from the respective service; and
displaying the status of plurality of IP-based communication services.

16. The method of claim 15, further comprising:
initiating the at least one IP-based communication service by the central management function.

17. The method of claim 16, further comprising:
retrieving logon credentials for the at least one IP-based communication service from a database; and
providing the logon credentials to the at least one IP-based communication service.

18. A computer program product for managing a suite of communication services, the computer program product comprising:
a computer readable storage medium having computer readable program code embodied in said medium, said computer readable program code comprising:
computer readable program code configured to provide a central management function configured to manage the status of a plurality of communication services including at least one IP-based communication service and at least one non-IP based communication service;
computer readable program code configured to receive a status of the at least one IP-based communication service and the at least one non IP-based communication service at the central management function from the respective service; and
computer readable program code configured to display the status of at least one IP-based communication service and the status of the at least one non IP-based communication service.

19. A computer program product for managing a suite of communication services, the computer program product comprising:
a computer readable storage medium having computer readable program code embodied in said medium, said computer readable program code comprising:
computer readable program code configured to provide a central management function configured to manage the status of a plurality of IP-based communication services;
computer readable program code configured to receive a status of the plurality of IP-based communication services; and
computer readable program code configured to display the status of the plurality of IP-based communication services.
